(19) United States
(12) Patent Application Publication
(10) Pub. No.: US 2022/0079373 A1
(43) Pub. Date: Mar. 17, 2022

(54) METHOD AND MACHINE FOR PREPARING A BREWED BEVERAGE

(71) Applicant: Melitta Single Portions GmbH & Co. KG, Minden (DE)

(72) Inventors: Kerstin FERNANDES DE CARVALHO, Bielefeld (DE); Jan PAHNKE, Minden (DE); Holger FELDMANN, Willich (DE)

(73) Assignee: Melitta Single Portions GmbH & Co. KG, Minden (DE)

(21) Appl. No.: 17/420,258

(22) PCT Filed: Jan. 17, 2020
(86) PCT No.: PCT/EP2020/051143

§ 371 Date: Jul. 1, 2021

(30) Foreign Application Priority Data
Jan. 22, 2019 (DE) 10 2019 101 537.5

(51) Int. Cl. A47J 31/44; A47J 31/057; A47J 31/52; A23F 5/26; A23F 3/18; B65D 85/804

(52) U.S. Cl. CPC A47J 31/4478; A47J 31/057; A47J 31/5253; A47J 2202/00; A23F 5/26; A23F 3/18; B65D 85/8043; A47J 31/5255

(57) ABSTRACT

A method for preparing a brewed beverage has following steps: positioning a filter cartridge filled with an extraction material on a filter holder; heating water using a heating device and conveying the heated water to an inlet above the filter cartridge; moving the inlet relative to the filter cartridge in order to wet the extraction material with hot water, wherein the inlet moves relative to the filter paper cartridge in different patterns depending on the set brewing strength; the temperature of the supplied hot water is different depending on the set brewing strength, and/or the volume flow rate of hot water supplied through the inlet is different depending on the set brewing strength. A machine for preparing a brewed beverage performs the method.

The present invention relates to a method for preparing a brewed beverage according to the preamble of claim 1, and to a machine for preparing a brewed beverage according to the preamble of claim 8.

DE 10 2015 121 634 B4 discloses a coffee machine in which hot water is provided via an outlet device above a filter vessel in order to prepare coffee. In this case, the coffee strength can be set via a selector switch and, depending on the switch position, the hot water is delivered in different quantities to different outlet openings. Due to the stationary arrangement of the outlet openings and the filter cartridge, the surface of the ground coffee is not evenly wetted, as is possible, for example, with hand brewing.

A coffee machine having a plurality of stationary outlet openings above a fixed filter holder is also shown in DE 20 2014 104 028 U1.

In DE 10 2018 114 588, it is therefore proposed to rotate the hot water feed of a coffee machine during the brewing process. This makes it possible to provide annular paths of movement for the feed openings in order to obtain more uniform wetting of the ground coffee. The annular path of movement means that only part of the surface of the ground coffee is wetted, and the adjustment of the brewing strength is achieved only by selecting the outlet openings.

It is therefore an object of the present invention to provide a method and a machine for preparing a brewed beverage, with which improved extraction is achieved and different brewing strengths can be adjusted.

This object is solved with a method having the features of claim 1 as well as a machine having the features of claim 8.

In the method according to the invention, the brewing strength can be adjusted, wherein optionally the relative movement of the feed to the filter cartridge is performed in different patterns depending on the adjusted brewing strength, the temperature of the supplied hot water is differently high depending on the adjusted brewing strength and/or the volumetric flow rate of hot water flowing through the feed is differently high depending on the set brewing strength. As a result, the brewing strength can be changed by one or more of the above measures, with otherwise the same amount of extraction material and the same beverage volume, in order to produce an optimized brewed beverage.

The relative movement of the feed to the filter cartridge can take place in different patterns. Either the feed or the filter cartridge can be moved by a drive, and optionally both the feed and the filter cartridge can be moved during the brewing process. By moving the feed relative to the filter cartridge, the hot water can be applied to a surface of the extraction material in different patterns, so that a comparatively large area of the extraction material is wetted with hot water.

The surface area covered by the feed is determined by the size of the feed and the relative movement between the feed and the filter cartridge during the brewing process, i.e. while hot water is flowing out of the feed. The size of the opening or openings of the feed is multiplied by the distance of travel of the feed relative to the filter cartridge, so that the area of the path of movement is obtained. Subtracted from this are areas that are covered twice by the feed. The surface area swept by the feed during brewing is preferably at least 10% of the total surface area of the extraction material, in particular between 20% and 70%. As a result, a particularly uniform extraction of the extraction material can be achieved, irrespective of the surface geometry of the extraction material, since almost all areas of the extraction material can be wetted.

In a preferred design, a small amount of water is first fed via the feed onto a still closed filter cartridge in order to open a closure device provided on the upper side of the filter cartridge by feeding the hot water. This opening can be effected, for example, by swelling processes, wherein the closure device can have one or more flaps which swing open as a result of the swelling processes, so that an upper opening of the portion pack is released for the brewing process. After the opening, hot water can then be supplied via the feed to wet the extraction material. This simplifies handling when preparing the brewed beverage, as the closed filter cartridge can be used already filled.

In the method according to the invention, when a strong brewing strength is set, hot water can be added via the feed for pre-brewing and then wait for a pause of at least 10 s, preferably between 15 s to 30 s, before hot water is added for further brewing. This intensifies the extraction, as the pre-brewing gives the extraction material sufficient time to expand and bloom.

When setting a mild brewing strength, there is preferably no pause between a pre-brew and a brew, but hot water is supplied continuously via the feed. This results in a lower degree of extraction, which leads to a milder taste.

In the method according to the invention, three different brewing strengths can preferably be set, wherein a different degree of extraction is obtained in the brewed beverage depending on the brewing strength set. For example, a mild brewing strength may have a degree of extraction between 18% to 20%, a medium brewing strength may have a degree of extraction between 19 to 21%, and a strong brewing strength may have a degree of extraction between 20 to 22%.

In the machine according to the invention, the brewing strength can be adjusted, wherein optionally the relative movement of the feed to the filter cartridge takes place in different patterns depending on the brewing strength set, the temperature of the hot water supplied is differently high depending on the brewing strength set, and/or the volumetric flow rate of hot water pumped through the feed by a pump or passed through by gravity is differently high depending on the brewing strength set. This enables the production of a brewed beverage with an optimized degree of extraction, depending on the user's taste and the set brewing strength.

The temperature of the water supplied can be higher at a stronger brewing strength than at a mild brewing strength, wherein the temperature difference is between 2° C. to 8° C., for example. The volumetric flow rate, i.e. the volume of hot water delivered per unit time, can also vary depending on the brewing strength, in particular by at least 10%. A higher volumetric flow rate means that the contact time of the extraction material with the hot water is shorter, so that a lower degree of extraction is achieved. This effect is enhanced in that a higher liquid level in the filter cartridge during preparation results in a larger active filter area, through which in turn more volume can flow off per unit of time.

In the machine according to the invention, the filter cartridge is preferably arranged on a stationary holder of the machine, and only the feed is movable by a drive. For example, the feed can be driven in several directions by a cam guide or other means in order to run different patterns during brewing. For example, as seen in top view, the feed can travel a pattern in the form of multiple circles of different diameters, a spiral, star-shaped, meander-shaped, and/or wave-shaped. In an alternative design, the filter cartridge can also be moved by a drive, wherein the feed is optionally also moved or arranged in a stationary position.

Preferably, a temperature sensor is provided upstream of the feed to allow a predetermined temperature to be set when hot water is fed to obtain a specific brewing strength.

In the machine according to the invention, a filter cartridge is preferably used as a portion pack, which has an openable closure device on an upper side and is inserted in a filled state. It is also possible to fill a filter cartridge on the machine first and to insert a filter cartridge without a closure device.

To mimic hand brewing when preparing the brewed beverage, especially coffee, the feed can have only a single opening on its underside through which hot water flows.

The feed can then be moved in a predetermined pattern over a surface of the extraction material to mimic hand brewing.

The invention is explained in more detail below by means of several exemplary embodiments with reference to the accompanying drawings, wherein:

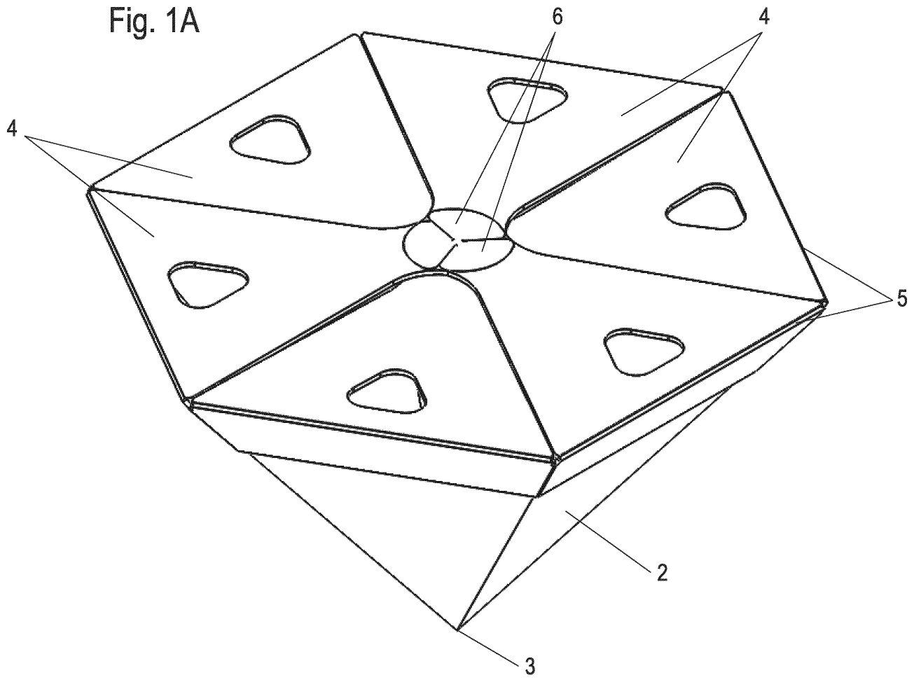

FIGS. 1A and 1B show two views of a portion pack for use in a machine according to the invention;

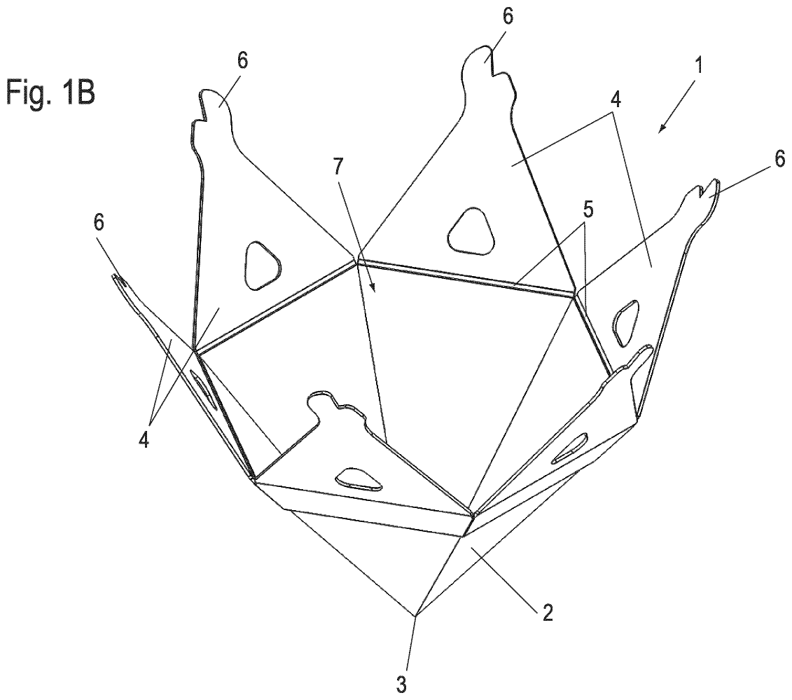

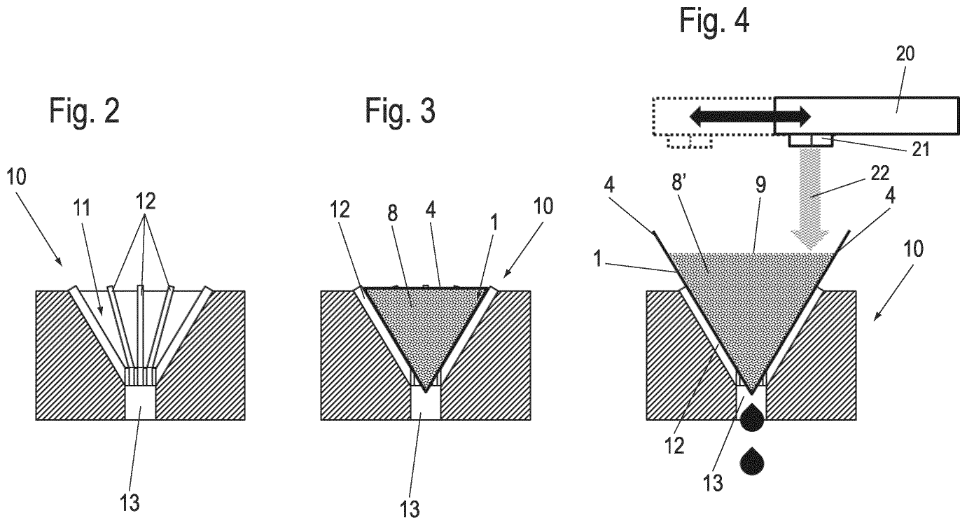

FIGS. 2 to 4 show several schematic views of a holder with a filter cartridge during preparation of a brewed beverage;

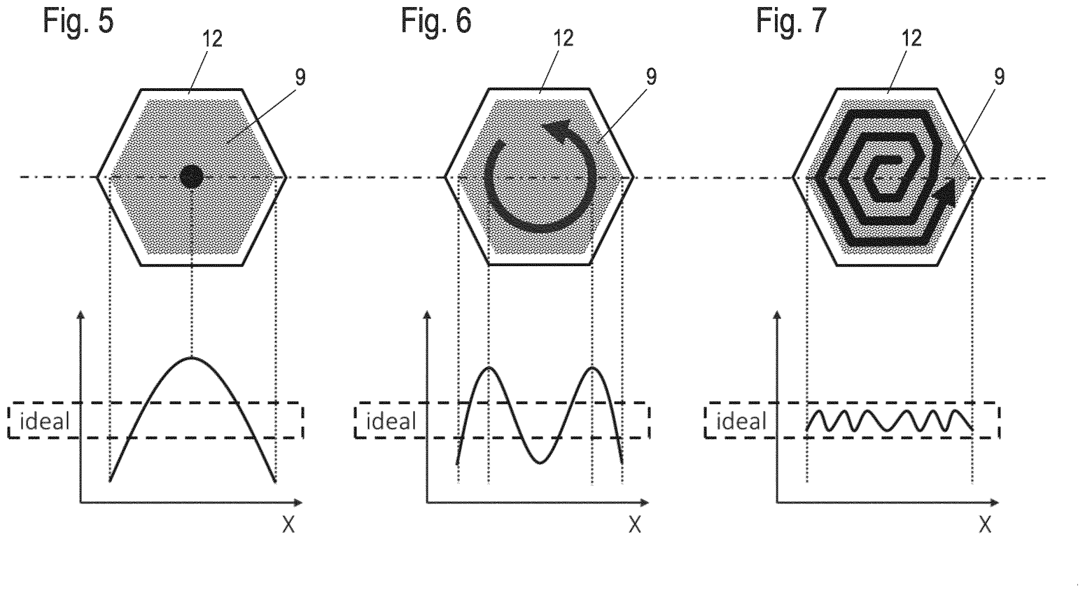

FIGS. 5 to 7 show several views explaining the relationship between the path of movement of the feed relative to the filter cartridge in terms of the degree of extraction;

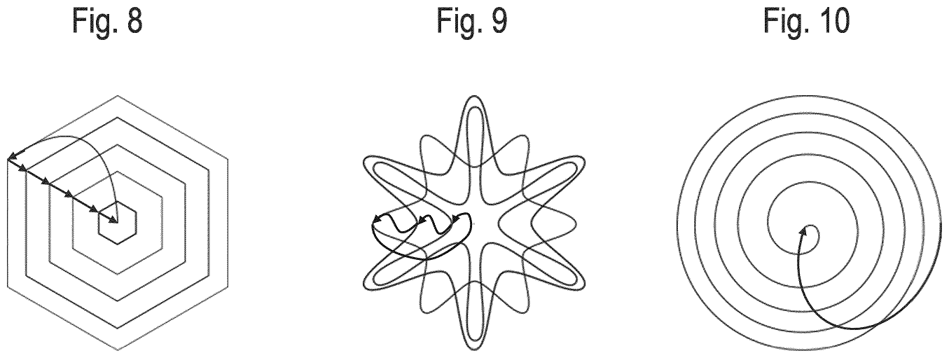

FIGS. 8 to 10 show several illustrations of patterns to show possible paths of movement of the feed relative to the filter cartridge;

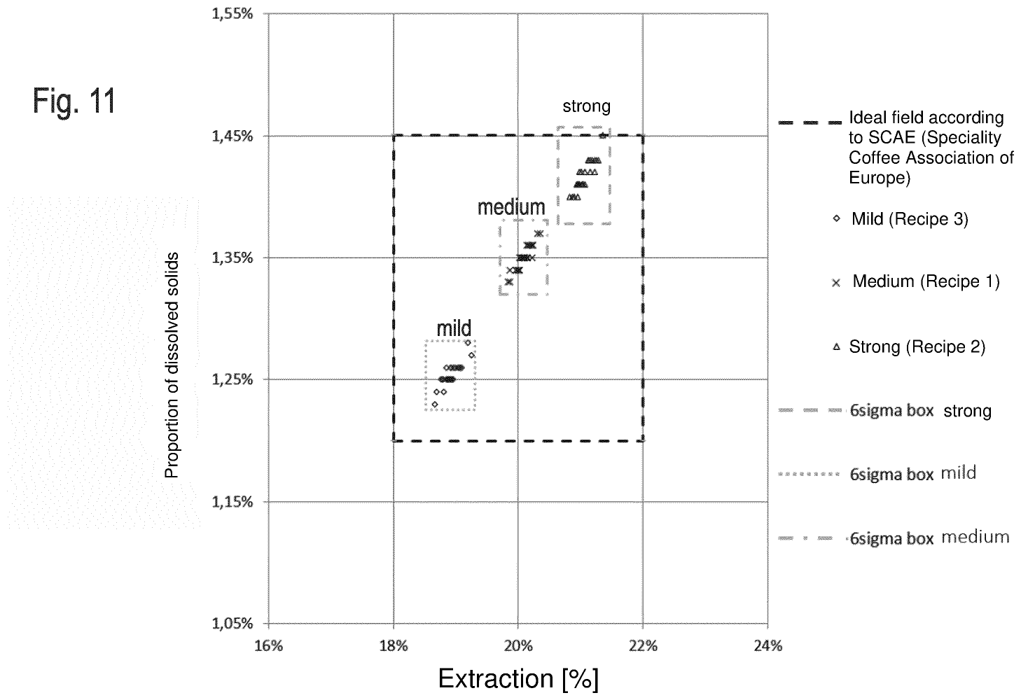

FIG. 11 shows a diagram showing the degree of extraction as a function of the set brewing strength, and

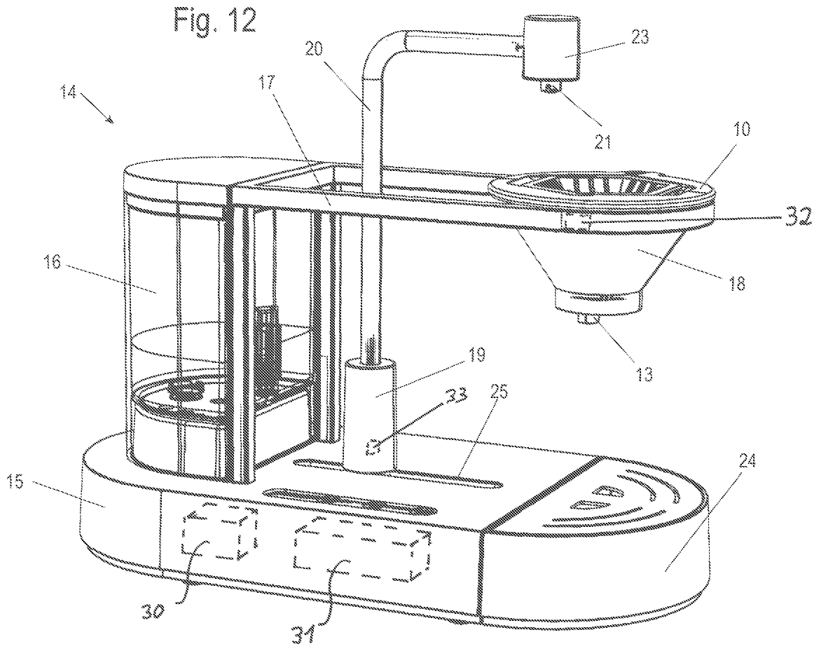

FIG. 12 shows a view of a machine according to the invention for preparing a brewed beverage.

A filter cartridge 1 is designed as a portion pack and comprises filter walls 2 made of a liquid-permeable material, which open out at a lower tip 3. The filter cartridge 1 is pyramid-shaped and comprises, on a top side which is substantially flat in the closed state, a closure device 4 which is formed from a plurality of pivotable flaps. The flaps can be pivoted via folding edges 5 and are essentially triangular in shape. Holding means 6 are provided at one end tip of the flaps, by means of which the flaps are locked together in a closed position.

When the filter cartridge 1 is to be opened from the closed position shown in FIG. 1A, a small amount of hot water can be applied to the top of the filter cartridge to initiate swelling processes that cause swelling, particularly at the folding edges 5, resulting in pivoting of the flaps and opening of the filter cartridge 1, as shown in FIG. 1B. The filter cartridge 1 can be designed as disclosed in the document DE 10 2018 101 338.

In the open position, an interior 7 of the filter cartridge 1 is accessible from above, wherein an extraction material, in particular coffee or tea, is filled into the interior 7.

To prepare a brewed beverage, a filter cartridge 1 may be inserted into a filter holder 10 as shown in FIG. 2. The filter holder 10 comprises an upwardly open receptacle 11, on which a plurality of ribs 12 protrude inwardly from the side walls. An outlet 13 for the brewed beverage is provided on the underside of the filter holder 10.

As shown in FIG. 3, the filter cartridge 1 shown in FIG. 1A can be inserted into the filter holder 10 with the filter cartridge 1 already filled with extraction material 8.

In FIG. 4, the filter cartridge 1 has been brought into an open position in which a mixture 8′ of the extraction material with water is accessible from above and an upper surface 9 can be wetted with water. For the brewing process, a feed 20 is provided which can be moved by means of a schematically shown drive in order to be able to travel over the surface 9 of the mixture 8′ with different patterns. Hot water 22, shown schematically, is fed from the feed 20 via an outlet opening 21 onto the surface 9 of the mixture 8′ in order to then collect the finished brewed beverage at the outlet 13.

FIGS. 5 to 7 show a top view of the filter cartridge 1, and illustrate how movement of the feed 20 relative to the filter cartridge 1 changes the extraction result.

In FIG. 5, the feed is rigidly arranged above the surface 9 of the extraction material, and hot water is fed only in the center. As the graphic below shows, an over-extraction is obtained in a central area, since all the hot water is fed into the central area, whereas in an edge area, hardly any hot water is passed through the extraction material, so that too little extraction takes place there. Only in a transition area between the edge area and the middle area is an optimum amount of hot water fed through the extraction material. Over-extraction and under-extraction worsen the resulting taste.

FIG. 6 shows a top view of filter cartridge 1 when a feed 20 rotating on an annular path is provided. The extraction result is improved by this, since although an over-extraction is still obtained in the area of the annular path of the feed, the degree of extraction is now in an optimized range at several points. Under-extraction occurs in the edge area and in the center, since too little hot water is passed through the extraction material there as well.

FIG. 7 shows a spiral pattern that can be obtained by a relative movement between filter cartridge 1 and feed 20. This pattern optimizes the degree of extraction, since the surface area of the upper side 9 covered by the feed 20 is increased, so that over- or under-extraction no longer occurs, but the extraction material is extracted in an ideal range. This allows optimized adjustment of the extraction and the brewing strength.

FIG. 8 shows a pattern of a path of movement of the feed 20 relative to the surface 9, in which hexagonal annular paths are traversed, each of which has a different radius. This allows the surface 9 to be optimally wetted with hot water.

FIG. 9 shows a substantially star-shaped path of movement of the feed, which is moved relative to the surface 9 of the extraction material in order to wet the surface 9 as fully as possible with water.

FIG. 10 schematically shows a spiral motion path.

The movement of the feed 20 relative to the surface 9 preferably causes the opening or openings on the feed to sweep a surface area during the brewing process that is at least 10%, preferably between 20% to 70%, of the surface area of the extraction material. This prevents areas of the extraction material from being subjected to under-extraction.

FIG. 11 shows an extraction diagram, wherein the degree of extraction is plotted on the X-axis and the TDS value in percent on the Y-axis. This is a chemical parameter and represents, as an abbreviation for the English expression ‘total dissolved solids’, the totality of all inorganic and organic substances dissolved in a solvent. In the extraction of coffee grounds, it represents the strength of the coffee beverage. In Europe, a value between 1.2% and 1.45% is considered ideal for filter coffee.

By adjusting the brewing parameters, a different brewed beverage can be obtained with the same filter cartridge 1 with extraction material, which has a different degree of extraction. For example, with the “mild” setting, the temperature of the hot water can be set between 87 and 89° C. The flow rate of hot water may be between 200 ml/min and 220 ml/min, with no pause between a pre-brew and a brew. The pattern of the feed 20 can be selected, for example, as shown in FIG. 8, with the outer tracks being run more frequently than the inner tracks in order to wet the edge areas of the pyramid-shaped filter cartridge 1 more with water and thus produce a milder brewed beverage.

If the “medium” brew setting is selected, the temperature of the hot water supplied can be between 91° C. and 93° C., for example. By reducing the volumetric flow rate to 150 to 170 ml/min, the dwell time of the hot water on the extraction material is extended, which increases the degree of extraction. Optionally, a pre-brewing may additionally take place, in which a certain amount of hot water is first added to the extraction material 8, in order to then provide a waiting time for the extraction material to unfold, for example between 5 s and 15 s, before further hot water is then added to the filter cartridge 1 during brewing. The pattern of movement of the feed can be selected according to FIG. 8 or also according to the outer areas of FIG. 8 combined with FIG. 9.

When setting a brewing strength of “strong”, the temperature of the hot water supplied can be increased, for example to a range between 93° C. to 96° C. In addition, the volumetric flow rate can be reduced to an amount between 100 to 120 ml/min. Furthermore, to increase the degree of extraction, a pause can be provided between a pre-brewing and the actual brewing process, for example between 15 s and 30 s. This allows the extraction material to swell after an initial application of hot water, and only then is further hot water applied to increase the degree of extraction. The feed movement can follow a predetermined pattern, for example according to FIG. 9 or FIG. 8 with focus on the inner tracks, so that in particular more water is added in the central area than in an edge area, since the height of the extraction material is greater in the central area due to the pyramid shape.

Thus, by adjusting various parameters, the degree of extraction of the brewed beverage can be adapted to the user's taste, wherein the degree of extraction is preferably in a range of 19% for the “mild” setting, in a range of 20% for the “medium” setting, and in a range of 21% for the “strong” setting.

FIG. 12 shows a machine 14 for preparing a hot beverage, which comprises a base station 15 having a housing in which a heating device, a pump and a controller are arranged. A removable tank 16 for fresh water is provided at the base station 15, via which water can be conveyed to the pump, the heating device and to a feed 20. The feed 20 is designed as a pipeline projecting upward from the base station 15. The feed 20 is not stationary on the housing of the base station 15, but can be moved by a drive unit. A carriage 19 is provided for this purpose, which can be moved linearly along a guide track under a slot 25 on the base station 15. In addition, the carriage 19 can be rotated via a further drive so that the feed 20 can be rotated about a vertical axis and can also be moved linearly along the guide track. Other drives can also be used to move the feed 20.

The feed 20 has a vertical section and a horizontal section, wherein the feed 20 opens out at an outlet opening 21, which is arranged above a filter holder 10, into which a filter cartridge 1 as shown in FIG. 1 can be inserted. Furthermore, a holder 23 is provided on the feed 20 above the outlet opening 21, on which, for example, a light source, in particular an LED light source, is provided, which can be controlled via a controller in the base station 15. In addition, an optical sensor may be provided on the holder 23 to detect whether or not a filter holder 10 is inserted on the holder 18. Optionally, such a sensor may also detect whether a filter cartridge is arranged in the filter holder 10 and/or whether an extraction material is arranged in the filter cartridge. For example, an optical sensor with corresponding color recognition can be used for this purpose.

The machine has a fixed holding device 17 on the base station 15, on which the bowl-shaped holder 18 is provided for detachable insertion of the filter holder 10.

An outlet 13 for the brewed beverage is provided on the underside of the holder 18, in particular for coffee or tea. A drip tray 24 is provided under the outlet 13 for receiving residual liquid.

### LIST OF REFERENCE NUMERALS

1 Filter cartridge
2 Filter wall
3 Tip
4 Closure device
5 Folding edge
6 Holding means
7 Interior
8 Extraction material
8′ Mixture
9 Surface
10 Filter holder
11 Receptacle
12 Rib
13 Outlet
14 Machine
15 Base station
16 Tank
17 Holding device
18 Holder
19 Carriage
20 Feed
21 Outlet opening
22 Water
23 Holder
24 Drip tray
25 Slot

1. A method for preparing a brewed beverage in a brewing process, comprising the following steps:
a) positioning a filter cartridge (1) filled with an extraction material (8) in a filter holder (10);
b) heating water by a heating device and conveying the heated water to a feed (20) above the filter cartridge (1); and
c) moving a feed (20) relative to the filter cartridge (1) for wetting the extraction material (8) with hot water,
wherein
d) g relative movement of the feed (20) to the filter cartridge (1) occurs in different patterns depending on a set brewing strength;
e) g temperature of the conveyed heated water varies depending on the set brewing strength, and/or
f) g volumetric flow rate of the heated water flowing through the feed (20) varies depending on the set brewing strength.

2. The method according to claim 1, wherein g surface area swept with the feed (20) during the brewing process is at least 10% of g total surface area (9) of the extraction material (8), preferably between 20% to 70%.

3. The method according to claim 1, wherein a small amount of water is first applied to the still closed filter cartridge (1) via the feed (20), a closure device (4) provided on an upper side of the filter cartridge is opened by the application of the heated water, and the heated water is then supplied via the feed (20) for wetting the extraction material (8).

4. The method according to claim 1, wherein, when a strong brewing strength is set, hot the heated water is applied to the filter cartridge (1) via the feed (20) for pre-brewing and a pause of at least 10 s occurs before further brewing.

5. The method according to claim 1, wherein when a mild brewing strength is set, no pause is provided between a pre-brew and a brew and the heated water is continuously supplied via the feed (20) onto the extraction material (8).

6. The method according to claim 1, wherein the feed (20) is moved relative to the filter cartridge (1) in patterns in the form of several circles, a spiral, star-shaped, meander-shaped and/or wave-shaped.

7. The method according to claim 1, wherein three different brewing strengths can be set for the brewing process, at which a degree of extraction of the extraction terminal (8) is differently high.

8. A machine (14) for preparing a brewed beverage, comprising:
a feed (20) for hot water, the feed being is arranged above a liquid-permeable filter cartridge (1) with an extraction material (8),
wherein the the feed (20) is configured for supplying the hot water to a surface (9) of the extraction material (8) in order to collect the brewed beverage at an outlet (13) below the filter cartridge (1),
wherein the feed and/or the filter cartridge is configured such that a relative movement takes place between the filter cartridge (1) with the extraction material (8) and the feed (20) during the supply of hot water, and different brewing strengths are adjustable via a controller, wherein the controller is configured to control the feed such that:
a) the relative movement between the feed (20) and the filter cartridge (1) takes place in different patterns depending on the set brewing strength;
b) q temperature of the hot water supplied varies depending on the set brewing strength, and/or
c) q volumetric flow rate of hot water pumped through the feed (20) varies depending on the set brewing strength.

9. The machine according to claim 8, wherein the filter cartridge (1) is arranged on a stationary holder (10) of the machine and the feed (20) is movable by a drive.

10. The machine according to claim 8, wherein the feed (20) is arranged in a stationary manner on the machine and the filter cartridge (1) is movable by a drive.

11. The machine e according to claim 8, wherein the relative movement between the filter cartridge (1) with the extraction material (8) and the feed (20) results from a combination of a movement of the filter cartridge (1) and a movement of the feed (20).

12. The machine e according to claim 8, wherein a temperature sensor is provided upstream of the feed (20) and the supply of hot water at the feed (20) can be carried out at different temperatures depending on the set brewing strength.

13. The machine according to claim 8, wherein the filter cartridge (1) is designed as a portion pack which has an openable closure device (4) on an upper side.

14. The machine according to claim 8, wherein the feed (20) has a single opening on its underside through which the hot water flows.

15. The machine according to claim 8, wherein the controller is configured to set three different brewing strengths on the machine, with which a different degree of extraction can be produced in the brewed beverage.
